(19) United States
(12) Patent Application Publication
(10) Pub. No.: US 2025/0066103 A1
(43) Pub. Date: Feb. 27, 2025

(54) FILM FOR FOOD PRESERVATION

(71) Applicant: MILLBO S.R.L., Trecate (NO) (IT)

(72) Inventors: Piersandro PALLAVICINI, Pavia (PV) (IT); Lavinia Rita DOVERI, Pavia (PV) (IT)

(73) Assignee: MILLBO S.R.L., Trecate (NO) (IT)

(21) Appl. No.: 18/725,105

(22) PCT Filed: Dec. 27, 2022
(86) PCT No.: PCT/IB2022/062808

§ 371 Date: Jun. 27, 2024

(30) Foreign Application Priority Data
Dec. 28, 2021 (IT) 102021000032831

(51) Int. Cl. B65D 81/28; A21D 15/00; A23L 3/358; B32B 23/06; B32B 23/08; B32B 23/14; B32B 37/24

(52) U.S. Cl. CPC B65D 81/28; A21D 15/00; A23L 3/358; B32B 23/06; B32B 23/08; B32B 23/14; B32B 37/24; B32B 2250/02; B32B 2264/104; B32B 2264/303; B32B 2307/54; B32B 2307/7163; B32B 2307/7246; B32B 2307/7376; B32B 2317/12; B32B 2439/70

(57) ABSTRACT

The invention relates to a polymer film obtainable from the crosslinking reaction between pectin and carboxymethylcellulose in the presence of an organic calcium salt and a plasticiser. The film can comprise zeolite, loaded or not loaded with silver ions. The organic calcium salt is selected from: calcium propionate, calcium acetate, calcium lactate, calcium sorbate, calcium glutamate, calcium oleate, calcium palmitate, calcium laurate, calcium stearate and calcium myristate. The plasticising agent is a saturated or unsaturated fatty acid selected from: oleic acid and palmitic, stearic, lauric, myristic, myristoleic, palmitoleic and linoleic acid; polyethylene glycol; glycerol; glycerol derivatives; and citric acid salts, preferably sodium citrate. The polymer film can be laminated to at least one film/layer of plastic material, possibly biodegradable, or to a layer of paper and used for packaging foods, in particular baked products, with the aim of preserving them and extending their shelf life.

### FIELD OF THE INVENTION

The present invention relates to a composite polymer film based on materials deriving from renewable sources and usable in the food packaging industry to extend the shelf life of food products, in particular baked products.

### PRIOR ART

Food preservation technologies have the main aim of preserving the physical and nutritional properties of foods over time by preventing and/or limiting the proliferation, over time, of bacteria, fungi, moulds or other microorganisms, as well as delaying the oxidation of lipids, responsible for the phenomenon of rancidity.

It thus appears clear that the development of such technologies is of fundamental importance not only from a food safety perspective, but also as regards environmental sustainability, since greater and more effective food preservation can help to combat food waste.

Many foods, including baked products such as, for example, bread or biscuits, are characterised by a high water activity (a_{w}), which represents, in fact, the water available for microbial proliferation. This means that, despite their being baked at high temperatures, once they have come out of the oven these products will actually have a limited shelf life, as they are highly susceptible to contamination by moulds and bacteria naturally present in the surrounding air.

In other words, any baked product, if exposed to the surrounding environment and stored at room temperature, will develop a visible deterioration between 2 and 7 days.

It thus appears clear why, within the industry, increasing efforts have been focused on finding solutions that may allow such baked products to be kept for a longer time (i.e. the shelf life thereof to be increased). One of the most widely adopted solutions is to add, within the doughs or batters, additives with a preservative action that may delay and/or reduce deterioration by moulds and/or bacteria.

However, such additives are often of a “chemical” origin and thus not perceived by the consumer as “not natural”. There thus continues to be a need to provide new solutions for extending the shelf-life of the foods which, however, are perceived by consumers as natural and sustainable.

Polymer films usable as packaging for foods which, however, do not have properties of preserving or extending the shelf life of the foods, are known in the art, for example from Seslija et al. Macromol. Symp. 2018, 378. This publication describes the preparation, by means of the solvent casting technique, of a pectin- and carboxymethylcellulose-based polymer film in which calcium chloride is used as a crosslinking agent and glycerol as a plasticiser. The authors conclude their study on the mechanical properties of the film by affirming that the addition of carboxymethylcellulose and calcium chloride enhances the mechanical properties of the film compared to films based on pectin alone. The authors hypothesise using these films as food packaging but make no mention of any possible food preservation or shelf life extending properties. This is also because the substances employed do not in themselves have any antifungal/antibacterial action.

### SUMMARY OF THE INVENTION

The present invention relates to a pectin- and carboxymethylcellulose-based polymer film comprising a plasticiser and, as a crosslinking agent, an organic calcium salt having antibacterial/antifungal properties.

In one embodiment, the film comprises zeolite, optionally loaded with ionic silver (Ag⁺).

The polymer film is used as food packaging, for example, as packaging for baked products, as such or else laminated to a film commonly used as food packaging. In this case, the lamination between the film of the invention and the packaging film takes place, for example, by means of an adhesive and leads to the production of a laminated film in which the layer placed in contact with the food is the film of the invention, whereas the layer facing outwards is a packaging material commonly used in the industry for the specific type of food.

The subject matter of the invention thus also relates to a laminated film comprising at least one polymer film according to the invention and at least one polymer or paper film/layer normally used as food packaging, and the use thereof to package foods and to preserve and extend the shelf life thereof.

The subject matter of the invention of the invention further relates to a process for preparing the pectin- and carboxymethylcellulose-based polymer film of the invention which comprises a step of crosslinking the pectin and carboxymethylcellulose in the presence of an organic calcium salt, optionally in the presence of zeolite loaded or not loaded with silver ions, at a temperature comprised between 25° C. and 95° C. and a subsequent step of forming a polymer film with a substantially uniform thickness by spreading the reaction mixture containing the crosslinked ingredients on a surface with a blade positioned at a fixed height from the surface.

### BRIEF DESCRIPTION OF THE FIGURES

FIG. 1 shows a PEC/CMC 30%/Oleic acid 10%/CaCl₂ film: on the left, an SEM image of the film surface; on the right, SEM images of the film section;

FIG. 2 shows a PEC/CMC 30%/Oleic acid 10%/CaP film: on the left, an SEM image of the film surface; on the right, an SEM image of the film section;

FIG. 3 shows a PEC/CMC 30%/Oleic acid 10%/CaP, Ag 5% Z 10% film: on the left, an SEM image of the film surface; on the right, an image of the film section;

FIG. 4 shows a PEC/CMC 30%/Oleic acid 10%/CaA film: on the left, an SEM image of the film surface; on the right, an SEM image of the film section;

FIG. 5 shows a PEC/CMC 30%/Oleic acid 10%/CaA, Ag 5% Z 10% film: on the left, an SEM image of the film surface; on the right, an SEM image of the film section;

FIG. 6 shows the UV-Vis spectra of the film according to the invention;

FIG. 7 shows the UV-Vis spectra of the PEC/CMC/Oleic acid/CaP/AgZ film at different light exposure times.

### DETAILED DESCRIPTION OF THE INVENTION

For the purposes of the present invention, the expression “shelf life” indicates the period of time that corresponds, under certain storage conditions, to a tolerable decrease in food quality. The concept of shelf life is thus related to the concept of food quality, but one cannot disregard the microbiological aspect which contributes, together with physicochemical and enzymatic characteristics, to defining the food's fitness for consumption.

The polymer film of the invention derives from the crosslinking of carboxymethylcellulose and pectin in the presence of a plasticising agent and an organic calcium salt.

The plasticising agent is selected from: polyethylene glycol; a saturated or unsaturated fatty acid, for example selected from: oleic acid and palmitic, stearic, lauric, myristic, myristoleic, palmitoleic and linoleic acid; glycerol; glycerol derivatives such as ethylene glycol, acylglycerols, erythritol, xylitol, maltitol, sorbitol, mannitol; and citric acid salts, for example sodium citrate, potassium citrate and calcium citrate.

In one embodiment, the plasticising agent is oleic acid or glycerol.

The organic calcium salt has the function of a crosslinking agent and is selected from: calcium propionate, calcium acetate, calcium lactate, calcium sorbate, calcium glutamate, calcium oleate, calcium palmitate, calcium laurate, calcium stearate and calcium myristate.

In one embodiment, the crosslinking agent is calcium propionate or calcium acetate.

In addition to having a crosslinking function, the organic calcium salt also possesses an antibacterial and antifungal function.

In one embodiment, the polymer film comprises zeolite, which can comprise silver ions.

If the film comprises zeolite without silver ions, the zeolite influences the mechanical properties of the film (decrease in porosity, decrease in water vapour permeability), as demonstrated by the Applicant in the studies included herein.

When the zeolite is loaded with silver ions, in addition to influencing the mechanical properties, it imparts antibacterial and antifungal properties to the film, thus enhancing, in a synergistic manner, the action of the inorganic calcium salt. This effect as well has been demonstrated by the Applicant with comparative experiments included herein.

The Applicant has also demonstrated that the amount of silver ions released into the food to be preserved is below the limit of 0.05 mg/Ag/Kg of food established by the EFSA (European Food Safety Authority).

Furthermore, the zeolite has micrometric dimensions, in particular comprised between 1 and 100 microns, and can thus be used in contact with food, whereas ingredients of nanometric dimensions are prohibited by EFSA regulations.

The pectin- and carboxymethylcellulose-based polymer film derives from the crosslinking of these two ingredients in the presence of an organic calcium salt as described above. The crosslinking takes place at a temperature of between 25° C. and 95° C., preferably between 40° C. and 95° C., more preferably between 60° C. and 80° C. The reaction time varies according to the temperature and is for example comprised between 20 and 120 minutes.

In one embodiment, the crosslinking reaction takes place in the presence of a plasticising agent as described above and optionally in the presence of zeolite, loaded or not loaded with silver ions.

In particular, an aqueous solution of pectin (i) and an aqueous solution of carboxymethylcellulose (ii) are prepared by dissolving the two substances in water, preferably heating to facilitate dissolution.

The concentration of the pectin solution is preferably between 5 and 10% by weight.

The amount of carboxymethylcellulose used is preferably 10% to 40% by weight relative to the mass of pectin.

The plasticising agent is added to the pectin solution (i), preferably in an amount of 1% to 15% by weight relative to the mass of pectin.

The carboxymethylcellulose solution and the pectin and plasticising agent solution are mixed, preferably at a temperature comprised between 25° C. and 95° C., preferably between 40° C. and 95° C., more preferably between 60° C. and 80° C.

The organic calcium salt is added as a crosslinking agent to the aqueous solution thus obtained (iii), preferably in an amount of 2 to 4% by weight 5 relative to the pectin. In order to facilitate the reaction, the solution can be heated to a temperature comprised between 40° C. and 95° C., more preferably between 60° C. and 80° C., to obtain a viscous solution (iv).

In one embodiment, the zeolite containing or not containing silver ions is added to the solution (iii) in an amount comprised between 0 and 10% by weight relative to the pectin so as to obtain an aqueous suspension (iv-bis).

The solution (iv) or the suspension (iv-bis) is used to form a polymer film having a homogeneous thickness. The polymer film of homogeneous thickness is obtained by means of a blade positioned at a fixed distance from the surface on which the film is formed and by placing the solution/suspension in front of the blade, which is driven in line with the surface, thus creating a film of uniform thickness.

The polymer film of uniform thickness is preferably obtained using the technique just described.

In one embodiment, the thickness of the polymer film is comprised between 0.03 and 0.10 mm, preferably between 0.04 and 0.08 mm.

The polymer film thus obtained is dried at room temperature or by heating to a temperature comprised between 30° C. and 40° C.

In one embodiment, the polymer film is obtained from the crosslinking reaction between the pectin and carboxymethylcellulose in the presence of calcium propionate or calcium acetate and oleic acid or glycerol as the plasticising agent.

In a further embodiment, the polymer film comprises zeolite loaded with silver ions or zeolite not loaded with silver ions.

The zeolite loaded with silver ions is obtained by means of the known ion exchange technique, whereby the zeolite is maintained in suspension in an aqueous solution containing a source of silver ions, preferably under stirring. The source of silver ions is a silver salt selected from: silver nitrate, silver acetate, silver fluoride and silver sulphate.

The silver-loaded zeolite contains from 1% to 5% w/w of Ag relative to the mass of zeolite.

The polymer film has at least one of the following properties:
Elongation at break comprised between 7 and 10%, preferably between 7 and 9%; and/or
Tensile strength comprised between 45 and 85 N/mm², preferably between 50 and 75 N/mm²; and/or
Water vapour transmission comprised between 0.065 and 0.160 gh⁻¹ m⁻² and/or
Water vapour permeability 1.99×10⁻¹⁰ and 3.00×10⁻¹⁰ gh⁻¹ m⁻¹ Pa⁻¹

The film has antibacterial and antifungal properties even without the presence of silver-loaded zeolite, the properties being imparted by the organic calcium salt, particularly when the salt is calcium propionate or calcium acetate.

The presence of zeolite not loaded with silver influences the mechanical properties of the film. In particular, the comparative tests conducted by the Applicant have demonstrated that the film's porosity and the film's water vapour permeability decrease.

When the zeolite is loaded with silver, the antibacterial and antifungal properties increase considerably, a synergistic effect being created between the silver and the organic calcium salt.

Antifungal properties have been shown, for example, against Aspergillus niger, Penicillium janthinellum and wild-type Penicillium spp.

The capacity of the polymer film to preserve and extend the shelf life of foods makes it possible to avoid adding preservatives to the dough or batter for preparing the foods, with important positive impacts on consumer wellbeing. Furthermore, the film is totally biodegradable and compostable, as it is prepared from renewable raw materials.

By virtue of its antibacterial/antifungal properties, the polymer film may be used for the preservation of foods, in particular baked products such as, for example: bread, biscuits, filled baked products, croissants, leavened breakfast products, cakes and a combination thereof.

According to one embodiment, said foods are selected in the group consisting of jam and/or cream, preferably jam and/or pastry cream and/or breads.

Therefore, the subject matter of the invention relates to food packaging comprising the film of the invention and the use thereof to preserve foods, in particular to extend the shelf life of food products. The shelf life of food products depends on the product taken into consideration and is typically comprised between 1 day and 1 year.

In one embodiment, the packaging comprising the polymer film of the invention can consist solely of the film, thus providing a film for covering the food, or else it can be laminated to the packaging normally used for the type of food, thus providing a laminated film.

The packaging normally used for the foods can be made of conventional plastic material, e.g. polypropylene, polyethylene, polyethylene terephthalate or polystyrene, or else paper or biodegradable polymers, such as, for example, Mater-Bi, polylactic acid, polycaprolactone.

The packaging normally used for the foods can be a monolayer of one or more of the materials specified or else a bilayer, trilayer or multilayer made of one or more of the materials specified.

The lamination between the polymer film and the packaging normally used for the foods can be achieved, for example, by means of an adhesive.

The laminated film used as food packaging is positioned around the food so that the polymer film of the invention remains in contact with the food and thus exerts an antibacterial and antifungal action.

### EXAMPLES

MATERIALS: Pectin from citrus peel (PEC, galacturonic acid, ≥74.0% (dried basis), Sigma-Aldrich), Carboxymethylcellulose (CMC, average Mw 250,000, degree of substitution 0.7, Sigma-Aldrich), Oleic acid (OLA), 90%, Sigma-Aldrich), Zeolites (molecular sieves 4 A, powder, 325 mesh particle size, Sigma-Aldrich), Silver nitrate (Fluka), Calcium chloride (Merck), Calcium acetate monohydrate (Sigma-Aldrich), Calcium propionate (Millbo).

### Methods

Silver-loaded zeolites (AgZ): the silver zeolites were prepared with the ion exchange method. A precise amount of silver was dissolved in water as AgNO₃ at room temperature and the zeolite was added and mixed in the dark at room temperature for 16 hours to permit loading of Ag+ into the pores of the zeolite. A ratio in weight % was used to load the zeolites, in order to obtain 1 to 5% w/w Ag/Z. For 5% AgZ, 0.14 g of AgNO₃ (8.24×10⁻⁴ mOLAgNO₃, corresponding to 0.0889 g of Ag) were dissolved in 100 ml of water and then treated with 1.8 g of zeolites. For 1% AgZ, 0.028 g of AgNO₃ were used and the procedure was repeated in an identical manner. Afterwards, the AgZ powder was filtered and then washed with an abundant amount of water (3×15 mL of water) to remove the non-adsorbed Ag⁺.

Film preparation: Two solutions were prepared for the preparation of a polymer film:
i) 2.5 to 5.0 g of PEC dissolved in 50 mL of water at 80° C. under magnetic stirring; preferably, 3.0 g of PEC are dissolved.
ii) a second solution with CMC (10 to 40% by weight relative to the mass of pectin used in the solution (i), i.e. 0.3 to 1.2 g in the case where 3.0 g of pectin are used) in 25 mL of water, heated to 70° C. under magnetic stirring until complete dissolution.

The plasticiser, oleic acid (OLA), was added to the pectin solution (i) (amount of 1 to 10% by weight relative to the pectin, i.e. 0.03 to 0.3 g in the case where 3.0 g of pectin are used). Solution (i) and solution (ii) were mixed together at 75° C. under magnetic stirring. The following additives were then added:
a) silver-containing zeolites (AgZ) or pure zeolites (Z), from 0 to 10% wt (vs pectin, i.e. from 0 g to 0.3 g of zeolites where 3.0 g of pectin are used) were suspended in a small amount (1 mL) of water and were added.
b) Ca²⁺ salts (as crosslinking agents): calcium chloride (CaCl₂), or calcium acetate monohydrate (CaAc), or calcium propionate (CaP), in an amount ranging from 2 to 4% by weight relative to the pectin (i.e. from 0.06 g to 1.2 g of Ca salt where 3.0 g of pectin are used) were dissolved in 25 mL of water and added to the solution obtained from (i)+(ii) under vigorous stirring for 30 min at 75° C. and then at room temperature;
c) Precursor solutions for formation of films were prepared also without any addition of zeolites, or with zeolites not containing Ag (indicated as Z). The solutions prepared (with the concentrations in (a) and (b) as described above) were the following:
Sol (i)+Sol (ii)+CaCl₂
Sol (i)+Sol (ii)+CaCl₂+Z
Sol (i)+Sol (ii)+CaCl₂+AgZ
Sol (i)+Sol (ii)+CaAc
Sol (i)+Sol (ii)+CaAc+Z
Sol (i)+Sol (ii)+CaAc+AgZ
Sol (i)+Sol (ii)+CaP
Sol (i)+Sol (ii)+CaP+Z
Sol (i)+Sol (ii)+CaP+AgZ

In order to obtain polymer films with a precise, homogeneous thickness, use is made of a manual instrument of the “doctor blade” type, wherein a blade set at a fixed distance from the surface spreads the solution/suspension placed in front of it, moving in line with the surface and creating a film of uniform thickness. The blade is adjusted to a height of 1200 μm from the base. Two 12×20 cm sheets are prepared with the amounts described. They are then kept in an oven at 40° C. for 14 hours. The average thickness of the film is 0.05 mm.

### Characterisation:

The mechanical properties (tensile strength-TS and elongation at break-E %) were determined using a TA.XT Texture Analyzer (Stable Micro Systems, Godalming, UK), equipped with a 5 kg load cell. Before testing, the film thickness was measured by means of a Sicutool 3955 G-50 apparatus (Sicutool, Milan, Italy). Each film was cut (1×3 cm) and then clamped onto A/TG tensile grips; an initial distance of 1 cm between the grips was set. The upper grip was raised at a constant speed of 0.5 mm/s up to a distance of 10 mm.

The water vapour permeability (WVP) and water vapour transmission (WVT) tests were conducted according to the standard method ASTM E96. The samples with an exposed area of 0.02512 m² were sealed onto a circular opening in a vial, in a dryer at room temperature and at a relative humidity (RH) of 75%. In order to maintain an RH gradient of 75% through the film, anhydrous calcium chloride (0% RH) was placed within the cell and a saturated solution of sodium chloride (75% RH) was used in the dryer. After conditions of a stationary state had been reached, weight measurements were carried out for 24 hours.

Release of Ag onto bread. 100 mg portions of each film (3×4 cm) were placed in contact with a slice of “Pan Bauletto” (soft sandwich bread; 3×4 cm=5 g) and wrapped in aluminium foil in a glass bowl with 100% RH at room temperature for 1, 3, 7 days. After each period the bread was mineralised (1:5 H₂O₂—HNO₃ at 100° C. for 30 min) and 1 mL was drawn and diluted to 5 mL. The sample was analysed by ICP-OES using a Perkin Elmer Optima 3300 DV instrument.

SEM images. Morphological characterisation was carried out by scanning electron microscopy (SEM). As regards the zeolites, the samples were subjected to sputtering with carbon and analysed with a Zeiss EVO MA10 scanning electron microscope (SEM) (Carl Zeiss, Oberkochen Germany). The SEM-EDS analysis of the zeolites was obtained with the above-mentioned instrument coupled to an Xmax probe (Oxford). The images were acquired at a high voltage (20 kV), in a high vacuum, at room temperature and at different magnifications. The SEM images of the films were obtained with a Tescan Mira XMU-FEG SEM (Arvedi) on carbon-coated films. The films were also analysed with an SEM-EDS instrument.

The UV-Vis absorption spectra were recorded on a Varian Cary 6000 spectrophotometer with a dedicated sample holder for the films.

### UV-Vis Spectra

The UV-Vis absorption spectra were recorded on a Varian Cary 6000 spectrophotometer with a dedicated sample holder for the films after 1, 6, 24, 48 hours of exposure to ambient lighting (sunlight+neon light of the laboratory).

### Test on Antimicrobial Activity

The antimicrobial activity of the CaP films, functionalised or not functionalised with Ag, was assessed against three fungal strains, Aspergillus niger ATCC 16404, Penicillium janthinellum ATCC 20312 and wild type Penicillium spp. The fungal suspensions were filtered with an initial inoculum of about 1-2×10⁵ CFU/ml (colony-forming units/ml) on cellulose acetate filter membranes with a porosity of 0.22 micron. The membranes were then deposited on Petri dishes containing culture medium/agar suitable for the growth of the selected microorganisms. The filter membranes were covered with film with CaP or with CaP+Ag for 96 hours.

Dishes containing filter membranes covered by film with CaCl₂ (control) were prepared in the same manner.

After the contact time, the filter membranes were recovered, washed by suspending them in sterile water with a standardised method; at the end of the washing procedure, dilutions of the microbial suspensions were performed to determine the microbial content with subsequent seeding in the plate and to calculate the microbiocidal effect.

The microbiocidal effect (ME) was calculated for every test organism and contact time according to the following equation:

ME=log Nc−log Nd

where Nc is the number of CFUs of the control microbial suspension and Nd is the number of CFUs of the microbial suspension in the presence of the CaP-CaP Ag films.

### Results

### Mechanical Properties:

| | Elongation at | | Tensile strength | |
|---|---|---|---|---|
| | break % | | (N/mm²) | |
| | av | sd | av | sd |
| FRUIT PACKAGING-Mater-bi | 198 | 27 | 26 | 1 |
| PEC/CMC30%/OLA10%/CaCl₂ | 7 | 1 | 49 | 6 |
| PEC/CMC30%/OLA10%/CaCl₂ | 4 | 1 | 31 | 8 |
| Z10% | | | | |
| PEC/CMC30%/OLA10%/CaP | 8 | 2 | 70 | 25 |
| PEC/CMC30%/OLA10%/CaP | 9 | 3 | 50 | 16 |
| Z10% | | | | |
| PEC/CMC30%/OLA10%/CaP Ag | 8 | 4 | 54 | 18 |
| 5% Z10% | | | | |
| PEC/CMC30%/OLA10%/CaA | 8 | 1 | 58 | 15 |
| PEC/CMC30%/OLA10%/CaA | 8 | 1 | 55 | 16 |
| Z10% | | | | |
| PEC/CMC30%/OLA10%/CaA Ag | 8 | 1 | 54 | 10 |
| 5% Z10% | | | | |

The films have low elasticity compared to the commercial Mater-bi polymer (used as a reference), but they are decidedly stronger, a characteristic that is suitable for long-term packaging. The best strength is obtained for films containing calcium propionate and zeolites (with or without silver).

### Thickness

Thickness(mm)

| | av | sd |
|---|---|---|
| FRUIT PACKAGING-Mater-bi | 0.01 | 0 |
| PEC/CMC30%/OLA10%/CaCl₂ | 0.05 | 0.01 |
| PEC/CMC30%/OLA10%/CaCl₂ | 0.05 | 0.01 |
| Z10% | | |
| PEC/CMC30%/OLA10%/CaP | 0.04 | 0.01 |
| PEC/CMC30%/OLA10%/CaP | 0.04 | 0.01 |
| Z10% | | |
| PEC/CMC30%/OLA10%/CaP Ag | 0.05 | 0 |
| 5% Z10% | | |
| PEC/CMC30%/OLA10%/CaA | 0.07 | 0.01 |
| PEC/CMC30%/OLA10%/CaA | 0.07 | 0.01 |
| Z10% | | |
| PEC/CMC30%/OLA10%/CaA Ag | 0.05 | 0 |
| 5% Z10% | | |

Thanks to the technique used, the film thickness is adjustable and homogeneous, with a low standard deviation.

### Water Vapour Transmission (WVT)—Water Vapour Permeability (WVP)

| | WVT((gh⁻¹m⁻²) | | WVP (gh⁻¹ m⁻¹Pa⁻¹) | |
|---|---|---|---|---|
| | av | sd | av | sd |
| FRUIT PACKAGING-Mater-bi | 0.092998 | 0.007522 | 3.69E−11 | 2.99E−12 |
| PEC/CMC30%/OLA10%/ | 0.152048 | 0.013529 | 4.02E−10 | 3.58E−11 |
| CaCl₂ | | | | |
| PEC/CMC30%/OLA10%/ | 0.155255 | 0.009778 | 3.08E−10 | 1.94E−11 |
| CaCl₂ Z10% | | | | |
| PEC/CMC30%/OLA10%/CaP | 0.151937 | 0.002443 | 2.21E−10 | 3.16E−11 |
| PEC/CMC30%/OLA10%/CaP | 0.100186 | 0.016074 | 1.99E−10 | 3.19E−11 |
| Z10% | | | | |
| PEC/CMC30%/OLA10%/CaP | 0.109972 | 0.008046 | 1.88E−10 | 1.41E−11 |
| Ag 5% Z10% | | | | |
| PEC/CMC30%/OLA10%/CaA | 0.067 | 0.002 | 2.15E−10 | 6E−12 |
| PEC/CMC30%/OLA10%/CaA | 0.069997 | 0.02 | 2.89E−10 | 9E−11 |
| Z10% | | | | |
| PEC/CMC30%/OLA10%/CaA | 0.068 | 0.005 | 2.8E−10 | 4E−11 |
| Ag 5% Z10% | | | | |

In the formulations containing acetate or calcium propionate (instead of calcium chloride) and zeolites (with or without silver), one observes a low water vapour permeability and transmission. The results are lower than those of the commercial mater-bi, indicating a better capacity to preserve moist foods such as bread and derivatives.

### Release of Silver Into Bread—Film Used PEC/CMC 30%/OLA 10%/CaP Ag 5% Z 10%

| | mg Ag in 5.0 g of | | mg/Kg of bread | | % Ag released vs total Ag |
|---|---|---|---|---|---|
| | bread | | calculated | | in the film fragments |
| | av | sd | av | sd | av |
| 1 d | 0.00014 | 4.9E−05 | 0.03 | 0.01 | 0.0024% |
| 3 d | 0.00017 | 4.2E−05 | 0.03 | 0.01 | 0.0032% |
| 7 d | 0.00021 | 2.5E−05 | 0.041 | 0.005 | 0.0037% |

### Release of Silver Into Bread—Film Used PEC/CMC 30%/OLA 10%/CaP Ag 5% Z 10%

| | | | |
|---|---|---|---|
| | mg Ag in 32 g | mgAg/Kg | % Ag |
| RH | of bread | of bread | released |

| 100% | av | std d | av | std d | av |
|---|---|---|---|---|---|
| 1G | 0.0013 | 0.0001 | 0.043 | 0.004 | 0.0013 |
| 3G | 0.0009 | 0.0002 | 0.030 | 0.005 | 0.0009 |
| 7G | 0.0010 | 0.0004 | 0.03 | 0.01 | 0.0010 |

The two tables showing the release of silver ions into bread demonstrate that, over a contact time of one to seven days, the amount of silver released into the bread is less than 0.05 mg/kg of bread (limit set by the EFSA). Furthermore, the amount of silver released is constant after the first day, indicating the absence of a risk of silver accumulating in the bread over long storage times.

### Microbiological Characterisation

| | PEC/CMC30%/ | PEC/CMC30%/OLA10%/ |
|---|---|---|
| | OLA10%/CaP | CaP Ag 5% Z10% |
| Fungal strain | ME | ME |
| Aspergillus niger | 3.36 | 3.64 |
| Penicillium | 2.70 | 4.71 |
| janthinellum | | |
| wild type | 2.11 | 3.94 |
| Penicillium spp. | | |

| | PEC/CMC30%/ | PEC/CMC30%/OLA10%/ |
|---|---|---|
| | OLA10%/CaA | CaA Ag 5% Z10% |
| Fungal strain | ME | ME |
| Aspergillus niger | 4.25 | 6.51 |
| Penicillium | 0.41 | 0.51 |
| janthinellum | | |
| wild type | 1.26 | 3.00 |
| Penicillium spp. | | |

The microbiocidal effect (ME) against the three strains of moulds examined ranges from 0.5 to 6.5 logarithmic units, thus with a reduction in active fungal colonies from one half to fractions of a millionth compared to the bread preserved in films obtained with calcium chloride as the crosslinking agent and without zeolites. The effect is considerable also with calcium acetate or calcium propionate alone within the film. The effect also increases by two orders of magnitude in the co-presence of silver zeolites.

### SEM Images

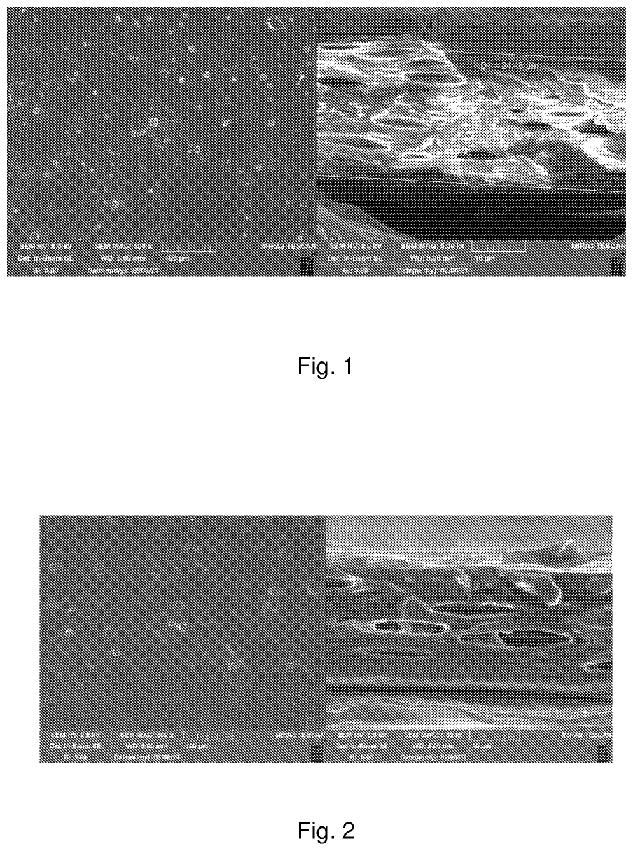

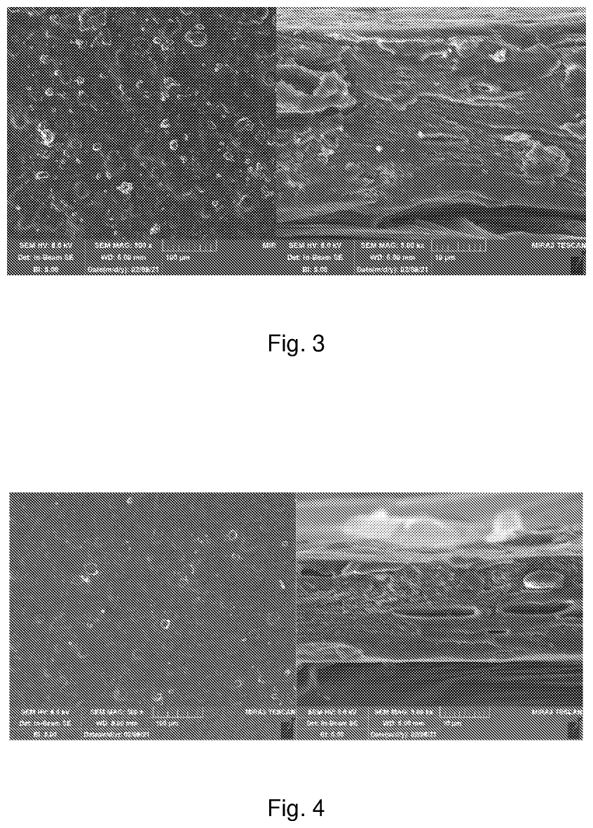

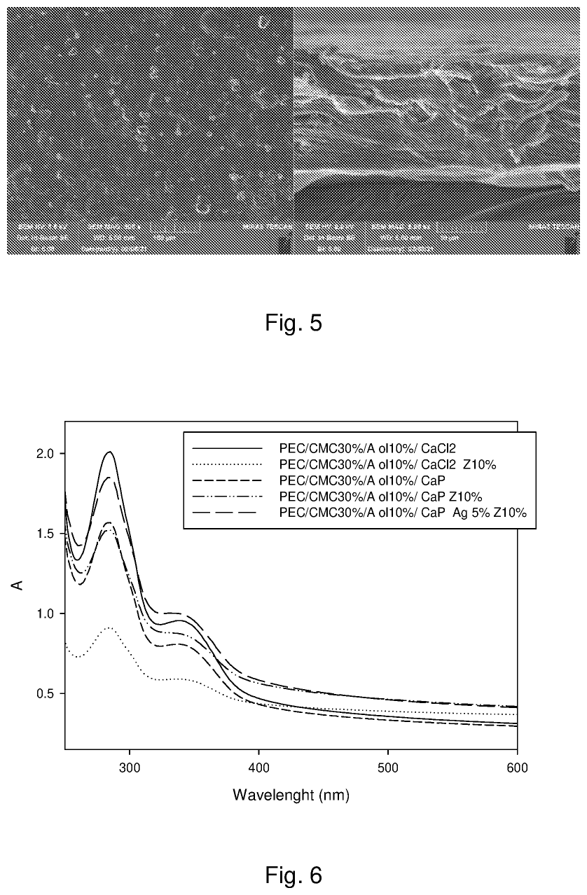

With reference to FIGS. 1-5, it should be noted that, both in the case of calcium propionate and in the case of calcium acetate as the crosslinking agent, the film's porosity decreases compared to the use of calcium chloride as the crosslinking agent, as may be noted particularly from the SEM images of the section.

The addition of zeolites further decreases the porosity with the formation of a particularly uniform, compact, homogeneous film. The observation is consistent with the decreased water vapour transmission and permeability revealed through independent experiments (WVT and WVP tables).

### UV-Vis Spectra

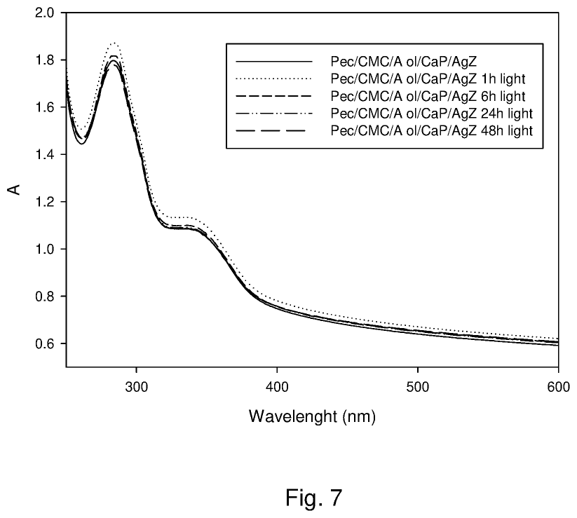

With reference to FIGS. 6 and 7, the spectra both on the freshly prepared films and on the films exposed to ambient lighting for 48 hours do not show any band in the typical position of silver nanoparticles (400 nm), demonstrating that the silver remains in ionic form. The bands that are noted in the spectrum at a wavelength of less than 400 nm are the ones characteristic of pectin.

1-10. (canceled)

11. A film configured for food packaging, the film comprising:
carboxymethylcellulose;
pectin;
an organic calcium salt; and
a plasticizer; wherein the pectin and carboxymethylcellulose are crosslinked by the organic calcium salt.

12. The film according to claim 11, further comprising zeolite particles of 1 to 100 microns.

13. The film according to claim 12, wherein the zeolite particles comprise silver ions.

14. The film of claim 11, wherein the organic calcium salt is selected from: calcium propionate, calcium acetate, calcium lactate, calcium sorbate, calcium glutamate, calcium oleate, calcium palmitate, calcium laurate, calcium stearate and calcium myristate.

15. The film of claim 11, wherein the plasticizing agent is a saturated or unsaturated fatty acid selected from: oleic acid and palmitic, stearic, lauric, myristic, myristoleic, palmitoleic and linoleic acid; polyethylene glycol; glycerol; glycerol derivatives; and citric acid salts, preferably sodium citrate.

16. The film of claim 11, wherein the carboxymethylcellulose is used in an amount of 10% to 40% by weight relative to the mass of pectin; the plasticizing agent is used in an amount of 1% to 10% by weight relative to the mass of pectin; the organic calcium salt is used in an amount of 2 to 4% by weight relative to the mass of pectin; and the pectin is used in an amount of 5 to 10% by weight relative to the solvent.

17. The film of claim 11, having at least one of the following properties:
Elongation at break comprised between 7 and 10%
Tensile strength comprised between 45 and 85 N/mm2
Water vapor transmission comprised between 0.065 and 0.160 gh−1 m−2;
Water vapor permeability 1.99×10−10 and 3.00×10−10 gh−1 m−1 Pa−1; and
Uniform thickness of between 0.03 and 0.10 mm.

18. The film of claim 11, laminated to at least one film/layer of plastic material, biodegradable plastic material, or a layer of paper.

19. A method of preserving shelf-life of a food product, the method comprising:
packaging a food product with a film comprising:
carboxymethylcellulose;
pectin;
an organic calcium salt;
zeolite particles; and
a plasticizer; wherein the pectin and carboxymethylcellulose are crosslinked by the organic calcium salt; and
reducing fungal and microbial growth of the food product.

20. The method of claim 9, wherein the zeolite comprises silver ions.

21. The method of claim 9, wherein the food product is bread, biscuits, filled baked products, croissants, leavened breakfast products, cakes, jam, and/or cream.

22. A method of manufacturing a film for food preservation, the method comprising:
preparing a mixture of pectin and carboxymethylcellulose comprising an organic calcium salt at a temperature between 25° C. and 95° C.; and
solvent casting the mixture to provide a film.

23. The method of claim 10, wherein the solvent casting is to a polymer or paper surface providing a laminate.

24. The method of claim 10, wherein the mixture is crosslinked with the organic calcium salt.

25. The method of claim 10, wherein the mixture further comprises zeolite particles of between 1 to 100 microns.

26. The method of claim 10, wherein the zeolite particles comprise silver ions.
